(19) United States
(12) Patent Application Publication
(10) Pub. No.: US 2022/0165240 A1
(43) Pub. Date: May 26, 2022

(54) ELECTRIC GUITAR PICKUP SELECTOR SWITCH POSITION LOCK

(71) Applicant: Lance Robert McCormick, Chatsworth, CA (US)

(72) Inventor: Lance Robert McCormick, Chatsworth, CA (US)

(73) Assignee: Lance McCormick, Chatsworth, CA (US)

(21) Appl. No.: 17/105,589

(22) Filed: Nov. 26, 2020

(51) Int. Cl. G10H 3/18

(52) U.S. Cl. CPC G10H 3/183; G10H 3/181

(57) ABSTRACT

Mechanical methods for temporarily securing the pickup selector switch of an electronically amplified string musical instrument with multiple electromagnetic pickups into anyone of its available position.

### FEDERALLY SPONSORED RESEARCH

Not Applicable

### SEQUENCE LISTING OF PROGRAM

Not Applicable

### FIELD OF INVENTION

This invention is for electric guitars that have multi pickup arrangements activated individually or collectively by a multi position selector switch located on face of guitar, that consist of a body, neck, and plurality of strings under tension.

### BACKGROUND OF INVENTION

The core elements of the modern solid body guitar appeared in the mid 1950's, with the development and rise in popularity of the multi electromagnetic pickup models; a necessity arose for pickups to have a method of “on and off” switching. The Fender, Stratocaster, introduced in 1954, made the three pickup solid body guitar arrangement one of the most popular set ups. The instrument used a 5-way blade style pickup selector switch that has become the industry standard, in which the first position activates the neck pickup, second position; the neck and middle pickups, third position the middle pickup, fourth position the middle and bridge pickups, and fifth position the bridge pickup alone.

These blade pickup selectors move very easy and are designed to facilitate changes in pickup combinations with a very light touch during a performance. It became common for guitar players to use different pickup combinations in different sections of the same composition, as a way of enhancing orchestration and sophistication of the guitar's contribution to performance.

The easy of pickup selector movement is a great tool for tailoring instrument tone to sections of a song but it can also presents some minor draw backs. As it became a common practice to perform many rhythm guitar parts utilizing the neck pickup only, which places the pickup selector switch in the most forward position, the position closest to the performers strumming hand. Through discussions with many guitar players it became clear that there was a need for a product that could lock the pickup selector switch in one position in certain instances, as in, if the front pickup was desired for a songs entirety and said song required a very active strumming pattern, in such situation many guitarist inadvertently knocking the pickup selector switch out of position; which can have a distracting and negative effect on performance. Therefore the development of an Electric Guitar Selector Switch Position Lock was needed. Through the creation and addition of a mechanical method; by which the existing blade selector switch can be temporary secured in position; to prevent the inadvertent changing of electromagnetic pickup switch selector; during a performance while artist is actively strumming instrument, the solid body electric guitar's electronic performance controls are improved.

### SUMMARY OF INVENTION

Therefore it is the intention of this invention to introduce a number of mechanical methods by which an electric guitar pickup selector switch can be temporarily secured in one position. This invention was realized by the common place; inadvertent; dislodging of the electric guitar pickup selector switch while performer actively strums instrument; when said selector switch is located in one of the first four positions. With the introduction of a mechanical stopping mechanism that can temporarily lock the pickup selector switch in one of the available positions desired by performer; the electronic controls of the electric guitar are made more stable and have greater consistency; in regards to sound tailoring options provided by electromagnetic pickup selections; regardless of the activity presented to the area in proximity of said pickup selector switch via performers strumming appendage.

In the creation of a retro fit base plate that employs the same fastener points of existing guitar pickup selector switch; a sliding, latching, ratcheting, fastening, twist locking, temporary securing devise can be attached to said base plate and positioned behind pickup selector switch cap; preventing inadvertent movement of pickup selector switch from the passage of downward and upward strokes across guitar strings and electromagnetic pickups by performers hand.

### DISCLOSURE OF PREFERRED EMBODIMENT

Other object, features, and advantages will occur from the following description of the preferred embodiment and the accompanying drawings, in which:

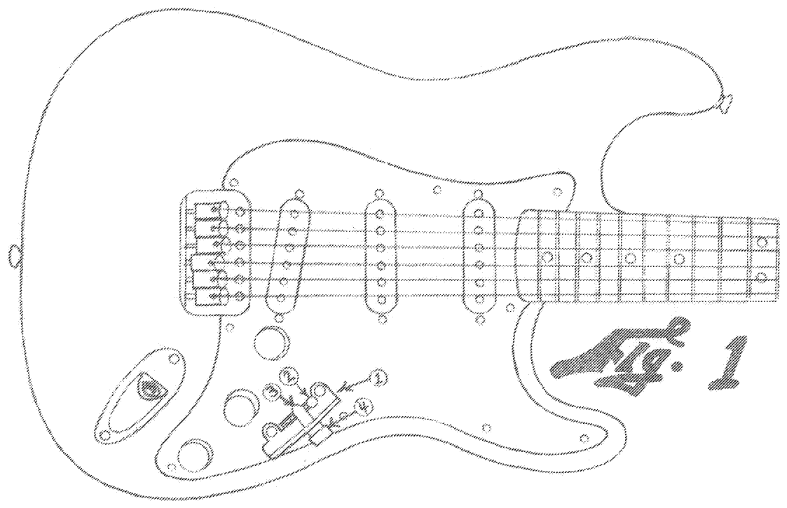

FIG. 1 Illustrates a face view of a solid body electric guitar with three electromagnetic pickups, indicating a method of fabrication for Electric Guitar Pickup Selector Switch Position Lock; in which the three component parts are represented; base plate is 1, selector switch lock retaining post 3, and switch lock retaining post adjustment knob 4, with pickup selector switch 2,

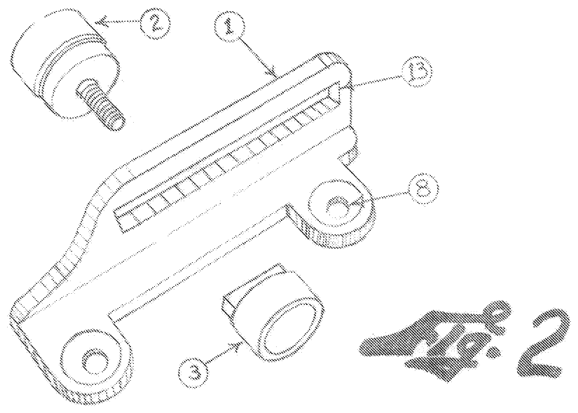

FIG. 2 Is an exploded view indicating the FIG. 1 fabrication method for the Electric Guitar Pickup Selector Switch Position Lock in which the base plate is 1, the selector switch retaining post is 3, and the switch lock retaining post adjustment knob is 2, adjustment track 13, mounting hole 8.

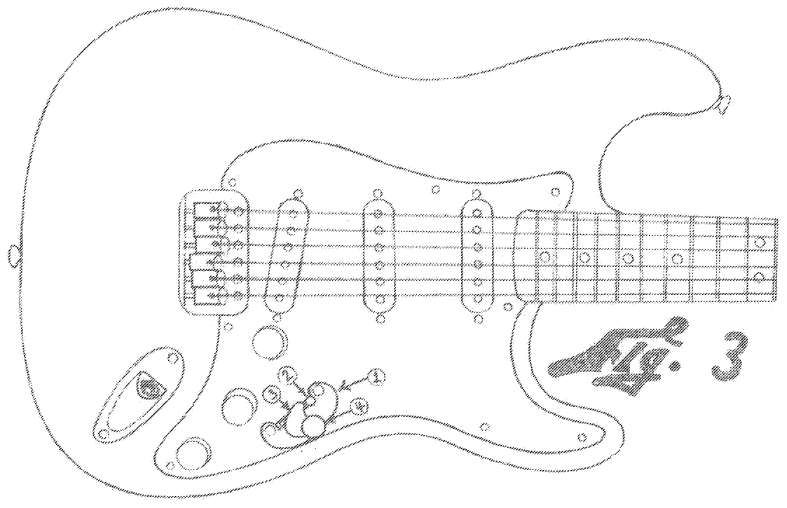

FIG. 3 Illustrates a face view of a solid body electric guitar with three electromagnetic pickups, indicating a second fabrication method for the Electric Guitar Pickup Selector Switch Position Lock in which base plate is 1, selector switch lock swing arm retaining plate 3, and switch lock retaining post adjustment knob 4, and pickup selector switch is 2.

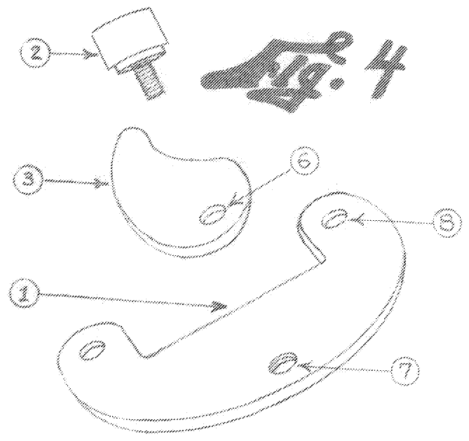

FIG. 4 Is an exploded view indicating the FIG. 3 fabrication method for the Electric Guitar Pickup Selector Switch Position Lock in which the base plate is illustrated by 1, mounting screw holes 8, adjustment and securing knob threaded mounting hole 7, the selector switch swing arm retaining plate 3, mounting hole 6, switch lock retaining post adjustment and securing knob 2.

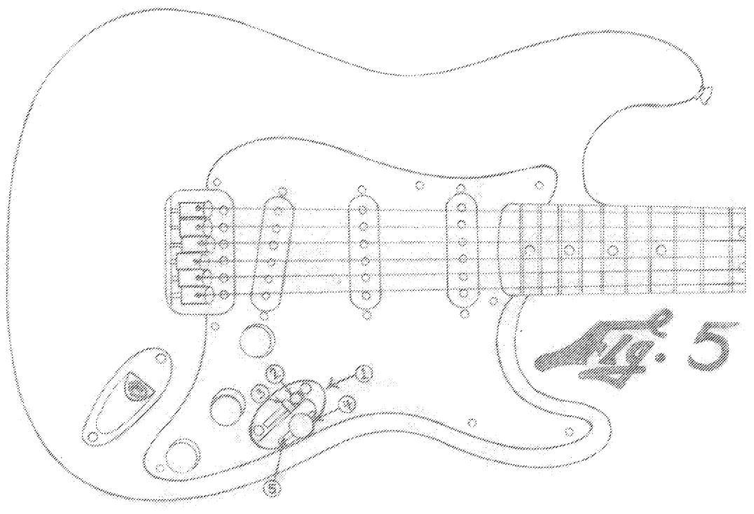

FIG. 5 Illustrates a face view of a solid body electric guitar with three electromagnetic pickups, indicating a third fabrication method for the Electric Guitar Pickup Selector Switch Position Lock in which the base plate is 1, selector switch lock retaining post 3, switch lock retaining post adjustment knob 4, retaining post and adjustment knob slot 5, and pickup selector switch is 2.

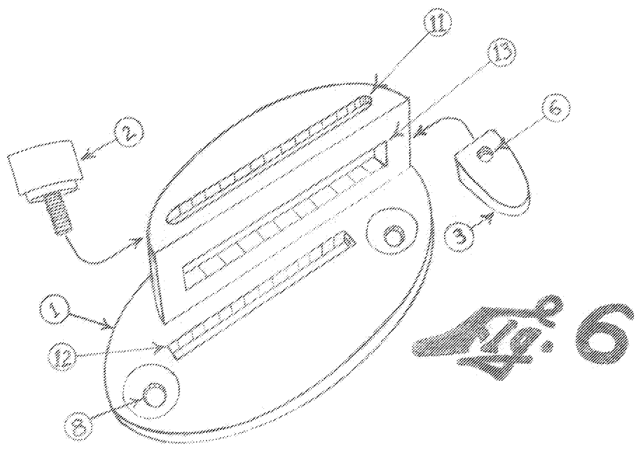

FIG. 6 Is an exploded view indicating the FIG. 5 fabrication method for the Electric Guitar Pickup Selector Switch Position Lock in which the base plate is illustrated by 1, mounting screw holes 8, pickup selector switch slot 12, the selector switch slide retaining plate 3, selector switch slide retaining plate mounting hole 6, selector switch slide retaining plate adjustment slot 13, slide retaining plate adjustment and securing knob 2, slide retaining plate adjustment and securing knob adjustment slot 11.

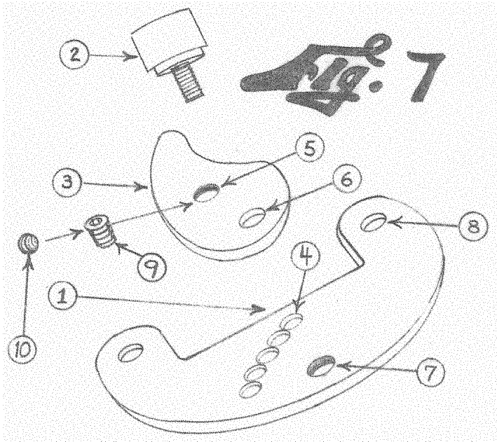

FIG. 7 Is an enhanced version of the FIG. 3/FIG. 4 fabrication method via the addition of corresponding pickup selector switch divot locations that can be added to top of base plate 1, or to bottom of selector switch swing arm retaining plate 3, in conjunction with set screw 9, or ball bearing 10, this design addition assists in locating the locking positions and enhances the security of position for the Electric Guitar Pickup Selector Switch Position Lock in which the base plate is illustrated by 1, threaded hole 7, for switch lock retaining post adjustment and securing knob 2, mounting screw holes 8, the selector switch swing arm retaining plate 3, selector switch swing arm retaining plate mounting hole 6, hole 5, for set screw 9, or ball bearing 10, employed as location finder for locking position divots 4.

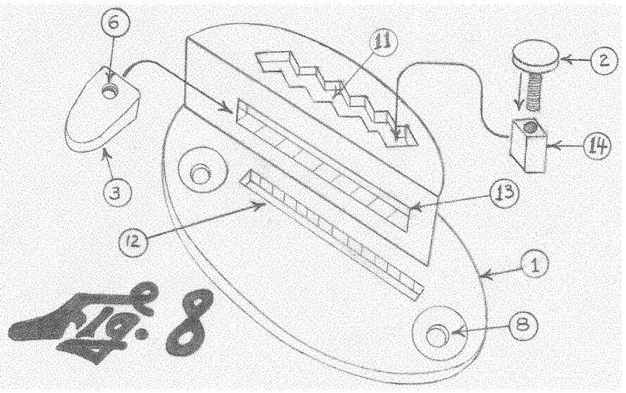

FIG. 8 Is an enhanced version of the FIG. 5/FIG. 6 fabrication method via the addition of corresponding pickup selector switch locking locations in slot 11, the combination of the switch lock slide retaining post adjustment and securing knob 2, which secures to twist lock neck block 14, into selector switch slide retaining plate mounting treaded hole 6, of selector switch slide retaining plate 3, allowing the Electric Guitar Pickup Selector Switch Position Lock to secure the pickup selector switch which is located and travels via slot 12, the additional elements are base plate 1, mounting screw holes 8, selector switch slide retaining plate adjustment slot 13.

1. A stringed musical instrument, electrically amplified, consisting of a resonating body; a neck having a elongated longitudinal section inset within at least the upper boundary of said body and a suspended plurality of magnetically sensitive strings under tension over said neck, fingerboard, and a portion of body in which multiple electromagnetic pickups are contained for generating small electric voltage via said strings vibrating within the magnetic field of said electromagnet pickups.

2. A string musical instrument as in claim 1. that features a retrofit pickup selector switch locking mechanism that can temporarily prevent said switch from being dislodged by inadvertent contact during a performance by musicians strumming appendage.

3. A stringed musical instrument as in claim 1. that features a mechanical devise made of any type of material; that can temporarily prevent the pickup selector switch from being moved to another position.

4. A stringed musical instrument as in claim 1. that utilizes a pickup selector switch locking device which employs the existing said pickup selector switch mounting fasteners as the method of mounting to said stringed instrument body face.

5. A stringed musical instrument as in claim 1. retro fitted with an Electric Guitar Pickup Selector Switch Position Lock in any of the forms depicted in the drawings FIG. 1 thur 8

6. A stringed musical instrument as in claim 1. in which there is a capability to temporarily lock the electromagnetic pickup selector switch into any of its available position with sufficient security to prevent dislodgement of said pickup selector switch by inadvertent contact from any part of the musicians body during a musical performance.

7. A stringed musical instrument as in claim 1. in which a mechanical devise can be retro fitted in proximity to pickup selector switch that has the capability to temporarily secure from movement said pickup selector switch.

8. Any addition to a stringed musical instrument as in claim 1. with multiple electromagnetic pickups and controlling switch that can temporarily lock said switch into anyone of the available pickup combination locations.

9. The addition of a retro fit devise to a stringed musical instrument as in claim 1. that has a specific design intention of providing to the player of said stringed instrument the ability to lock; temporarily; the pickup selector switch into any of the available positions.

10. A stringed musical instrument as in claim 1. that features a mechanical devised mounted with a parallel path of travel; to said stringed instrument pickup selector switch; capable of temporarily locking said switch; into any of its available selections of pickup combinations.

11. A stringed musical instrument as in claim 1. that features a mechanical devise with the capability of locking the pickup selector switch temporarily into any of its preset pickup combinations via a treaded fastener, twist lock fastener, spring loaded fastener, Velcro fastener, temporary adhesive material, clamping, or vise like method.
